(19) United States
(12) Patent Application Publication
(10) Pub. No.: US 2024/0066734 A1
(43) Pub. Date: Feb. 29, 2024

(54) RAZOR CARTRIDGE AND RAZOR ASSEMBLY

(71) Applicant: DORCO CO., LTD., Yongin-si (KR)

(72) Inventors: Dong Il KIM, Seoul (KR); KyoSun KIM, Seoul (KR); Kyong Sik LEE, Seoul (KR)

(21) Appl. No.: 18/504,612

(22) Filed: Nov. 8, 2023

Related U.S. Application Data
(63) Continuation of application No. PCT/KR2022/005940, filed on Apr. 26, 2022.

(30) Foreign Application Priority Data
May 11, 2021 (KR) 10-2021-0060540

(51) Int. Cl. B26B 21/40; B26B 21/22; B26B 21/52

(52) U.S. Cl. CPC B26B 21/4012; B26B 21/225; B26B 21/521

(57) ABSTRACT

A razor cartridge and a razor assembly are proposed. The razor cartridge may include a blade housing configured to receive at least one or more shaving blades in a longitudinal direction and a coupling hole formed in a rear surface of the blade housing. The razor cartridge may also include a connector including a coupling protrusion that is connected to the coupling hole and rotatable about a first rotational axis parallel to the longitudinal direction. The coupling protrusion may form a gap between the coupling hole to allow the blade housing to pivot about a second rotational axis perpendicular to the longitudinal direction.

### CROSS-REFERENCE TO RELATED APPLICATIONS

This is a continuation application of International Patent Application No. PCT/KR2022/005940, filed on Apr. 26, 2022, which claims priority to Korean Patent Application No. 10-2021-0060540 filed on May 11, 2021, the disclosure of each of which is incorporated by reference herein in its entirety.

### BACKGROUND

### Technical Field

The present disclosure in some embodiments relates to a razor cartridge and a razor assembly.

### Description of Related Technology

The statements in this section merely provide background information related to the present disclosure and do not necessarily constitute prior art.

Commonly known as a wet razor, a razor assembly includes a razor cartridge and a razor handle.

### SUMMARY

One aspect is a razor cartridge and razor assembly having multiple rotational axes, configured to provide restoring force during pivoting, and capable of conforming to the user's skin curvatures.

Another aspect is a razor cartridge including a blade housing configured to receive at least one or more shaving blades in a longitudinal direction and having a coupling hole formed in a rear surface of the blade housing, and a connector including a coupling protrusion that is connected to the coupling hole and rotatable about a first rotational axis parallel to the longitudinal direction, wherein the coupling protrusion forms a gap between the coupling hole to allow the blade housing to pivot about a second rotational axis perpendicular to the longitudinal direction.

Another aspect is a razor assembly including a blade housing configured to receive at least one or more shaving blades in a longitudinal direction and having a rear surface formed with a coupling hole, a connector including a coupling protrusion that is connected to the coupling hole and rotatable about a first rotational axis parallel to the longitudinal direction, and a restoring force-providing unit configured to provide restoring force for restoring the blade housing when pivoting to a first resting position, wherein the coupling protrusion forms a gap between the coupling hole to allow the blade housing to pivot about a second rotational axis perpendicular to the longitudinal direction.

As described above, the present disclosure in some embodiments can provide a razor cartridge and razor assembly with multiple rotational axes and a configuration for providing restoring force when pivoting to conform to the user's skin curvatures.

### BRIEF DESCRIPTION OF THE DRAWINGS

FIG. 1 is an exploded rear perspective view of a razor assembly according to at least one embodiment of the present disclosure.

FIG. 2 is an exploded front perspective view of a razor assembly according to at least one embodiment of the present disclosure.

FIG. 3 is an assembly perspective view of some components of a razor assembly according to at least one embodiment of the present disclosure.

FIGS. 4A and 4B are side cross-sectional views of some components of the razor assembly shown in FIG. 3, cut in the C-C′ direction of FIG. 3.

FIGS. 5A and 5B are side views illustrating pivoting about a first rotational axis of a razor cartridge, according to at least one embodiment of the present disclosure.

FIGS. 6A to 6C are rear views illustrating pivoting about a second rotational axis of a razor cartridge, according to at least one embodiment of the present disclosure.

FIG. 7 is a rear assembly perspective view of some components of a razor assembly according to at least one embodiment of the present disclosure.

FIGS. 8A and 8B are side cross-sectional views of some components of the razor assembly shown in FIG. 7, cut in the D-D′ direction of FIG. 7.

### DETAILED DESCRIPTION

The razor cartridge is configured to be pivotable about the razor handle between a rest position and pivoting positions away from the rest position. The razor cartridge makes a pivoting motion fundamentally about a rotational axis parallel to the alignment direction of shaving blades.

The pivoting motion of the razor cartridge about the rotational axis parallel to an alignment direction of the shaving blades helps to ensure that the shaving blades make good contact with the user's skin, thereby facilitating an efficient shave.

To implement the pivoting motion of the razor cartridge, conventional razor cartridges use a rotary connecting method or a fixed connecting method. In the rotary connecting method, the connector is configured to be fixed in position against the razor handle and rotatable with respect to the razor cartridge about a rotational axis. In the fixed connecting method, the connector is configured to be fixed in position against the razor cartridge and rotatable with respect to the razor handle about a rotational axis.

However, both the rotary connecting method and the fixed connecting method are configured to allow pivoting about a rotational axis parallel to the alignment direction of the shaving blades, but not, for example, pivoting about a rotational axis perpendicular to the alignment direction of the shaving blades.

To ensure that the shaving can proceed across varying skin curvatures with the shaving blades maintaining close contact with the skin, there is a need for a razor cartridge capable of pivoting about various rotational axes.

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Additionally, various ordinal numbers or alpha codes such as first, second, i), ii), a), b), etc., may be prefixed. These numbers and codes are solely used to differentiate one component from the other but not to imply or suggest the substances, order, or sequence of the components. Throughout this specification, when a part “includes” or “comprises” a component, the part is meant to further include other components, not to exclude thereof unless specifically stated to the contrary.

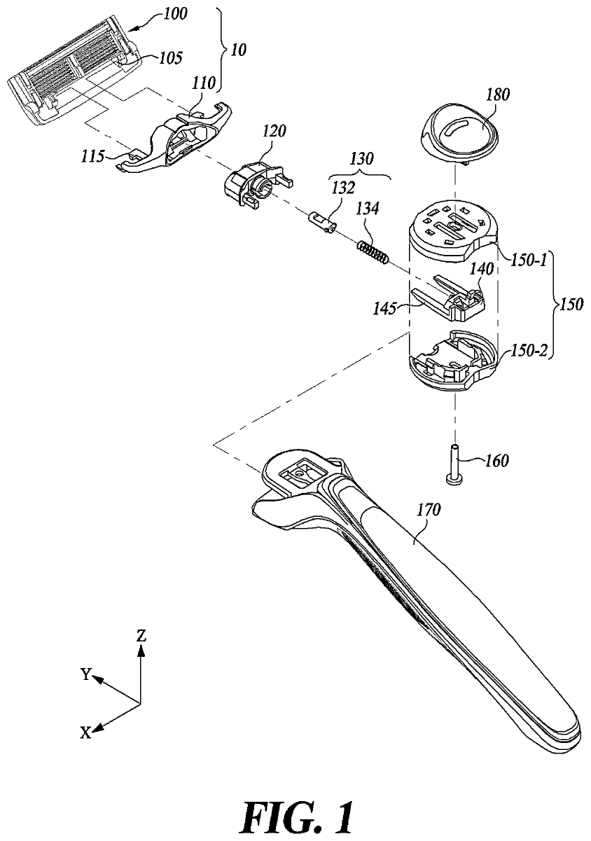

FIG. 1 is an exploded rear perspective view of a razor assembly according to at least one embodiment of the present disclosure.

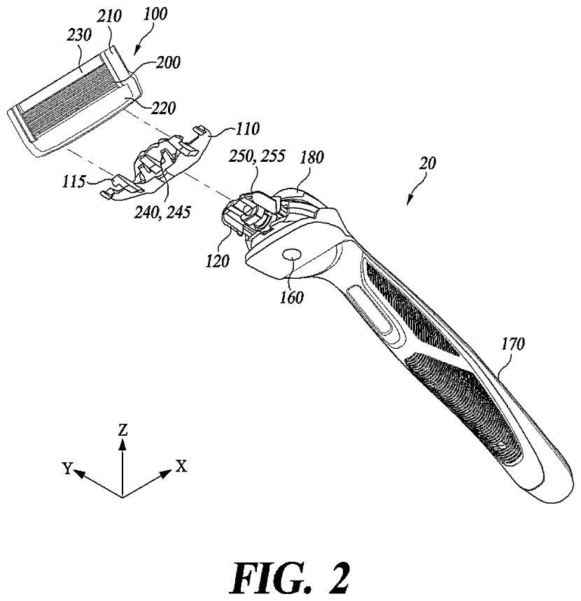

FIG. 2 is an exploded front perspective view of a razor assembly according to at least one embodiment of the present disclosure.

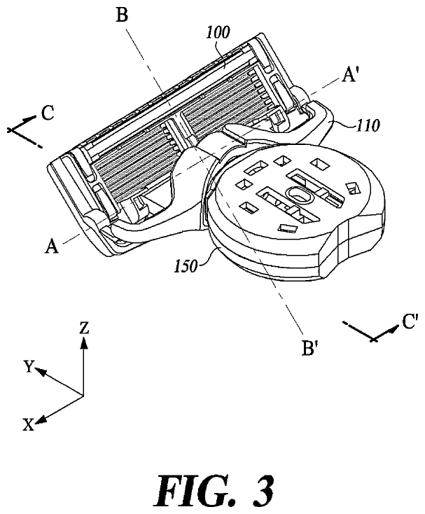

FIG. 3 is an assembly perspective view of some components of a razor assembly according to at least one embodiment of the present disclosure.

Referring to FIGS. 1 through 3, a razor assembly according to at least one embodiment of the present disclosure includes all or a portion of a razor cartridge 10 and a razor handle 20.

The razor cartridge 10 includes all or part of a blade housing 100 and a connector 110.

The blade housing 100 accommodates at least one shaving blade 200 in a longitudinal direction. As used herein, longitudinally refers to the direction in which the shaving blade 200 extends, for example, in FIG. 1, the longitudinal direction is parallel to the X-axis. The shaving blade 200 has a cutting edge extending longitudinally. There may be at least one, or a plurality of, shaving blades.

At least one shaving blade 200 received on one side of the blade housing 100 may be retained by a fixture, such as by a plurality of clips 210.

Additionally, the blade housing 100 may include a guard 220 and a cap 230. As described herein, a front side may be a side of the blade housing 100 toward which the cutting edge of the shaving blade 200 faces, and a rear side may be a side of the blade housing 100 that faces away from the front side.

On the front side of the blade housing 100, the guard 220 may be positioned forward of the shaving blade 200, and the cap 230 may be positioned rearward of the shaving blade 200. Herein, the forward and rearward of the shaving blade 200 are defined based on a shaving direction. However, as used herein, front and rear for components other than the shaving blade 200 refer to a positive y-axis direction and a negative y-axis direction in FIG. 1, respectively.

The guard 220 may stretch the skin in the direction of shaving, before the cutting of body hair by the shaving blade 200 during shaving. The guard 220 may hold the user's body hair upright in a direction perpendicular to the plane of the user's skin, thereby allowing the shaving blade 200 to more easily cut the body hair.

The cap 230 may be configured to include a lubrication material which may serve to protect the user's skin during shaving.

The blade housing 100 also includes one or more coupling holes 105 formed in the rear surface of the blade housing 100 for docking engagement with a connector 110.

The connector 110 is coupled to the blade housing 100. The connector 110 may be manufactured as a separate member from the blade housing 100 and then coupled to the blade housing 100 but is not necessarily limited to such a design. The connector 110 and the blade housing 100 may be manufactured as a single unit.

The connector 110 may include one or more coupling protrusions 115 for coupling with the blade housing 100. The one or more coupling protrusions 115 are rotatably connected to the one or more coupling holes 105 about a first rotational axis parallel to the longitudinal direction. Thus, the blade housing 100 may be rotated about the first rotational axis with respect to the connector 110. Herein, the first rotational axis may refer to the direction A-A′ in FIG. 3.

Referring to FIGS. 1 and 2, the razor handle 20 configured to be coupled with a razor cartridge according to at least one embodiment of the present disclosure includes, in whole or in part, a coupling housing 120, an accommodation housing 150, a restoring force providing unit 130, an ejecting unit 140, a grip unit 170, and a button unit 180.

The coupling housing 120 is coupled to the connector 110, for which the connector 110 may include a first connecting portion 240, and the coupling housing 120 may include a second connecting portion 250.

In this case, the first connecting portion 240 may include at least one cantilever 245 extending from one end of the connector 110. There may be at least one, or a plurality of, cantilevers 245. The cantilever 245 may extend from the connector 110 in a direction toward where the blade housing 100 is located or forwardly, but is not necessarily limited to such a design.

The second connecting portion 250 includes at least one hooked protrusion 255 configured for hook coupling with one end of the cantilever 245. There may be at least one, or a plurality of, hooked protrusions 255 which are preferably configured to be equal to the number of cantilevers 245.

The accommodation housing 150 joins the coupling housing 120. The accommodation housing 150 may be configured to include an upper accommodation housing 150_1 and a lower accommodation housing 150_2, as shown in FIG. 1. In this case, the coupling housing 120 may be coupled to the upper accommodation housing 150_1 and the lower accommodation housing 150_2 may be coupled to a lower portion of the upper accommodation housing 150_1, but the present disclosure is not necessarily limited to this arrangement.

The restoring force providing unit 130 is configured to provide restoring force to restore the blade housing 100 when rotated, to a first rest position. As used herein, the first rest position refers to a position corresponding to a state of the blade housing 100 when it is not rotated about the first rotational axis and is non-pressurized as described below.

After the blade housing 100 has been rotated about the first rotational axis relative to the connector 110, if no longer rotational torque acts on the blade housing 100 about the first rotational axis, the restoring force providing unit 130 may provide a restoring force to the blade housing 100 to return the same to the first rest position.

The restoring force-providing unit 130 may include a plunger 132 and an elastic member 134. In this case, the plunger 132 is configured to transmit the restoring force in cam action with the blade housing 100, and the elastic member 134 is configured to provide an elastic force to the plunger 132.

For example, when the blade housing 100 is rotated about the first rotational axis, the plunger 132 may be configured to move in the direction of the Y axis of FIG. 1 in response to the rotation of the blade housing 100 about the first rotational axis. Further, the elastic member 134 may be configured to contract when the plunger 132 moves in the negative Y-axis direction, in which case the elastic member 134 may provide positive Y-axis restoring force to the plunger 132. However, the restoring force providing unit 130 of the razor cartridge according to at least one embodiment of the present disclosure does not necessarily utilize the plunger 132 and the elastic member 134 to provide the restoring force.

Meanwhile, the elastic member 134 having one end connected to the rear end of the plunger 132 and the other end connected to the ejecting unit 140 may provide restoring force to the ejecting unit 140 when moved in the positive Y-axis direction. Thus, the ejecting unit 140 may be returned to its original position after being moved in the positive y-axis direction to disengage the coupling housing 120 and the connector 110.

The ejecting unit 140 is configured to separate the coupling housing 120 from the connector 110. For example, the ejecting unit 140 may be moved to abut and elastically deform the cantilever 245, thereby causing the cantilever 245 to disengage from the hooked protrusion 255. In this case, the ejecting unit 140 may include at least one or more push bars 145 for elastically deforming the cantilevers 245.

The grip unit 170 is connected to the accommodation housing 150 and becomes the part that the user grips for shaving. The grip unit 170 and the accommodation housing 150 may be connected by using a shaft 160 configured to pass through each thereof.

However, the accommodation housing 150 according to at least one embodiment of the present disclosure is not necessarily constructed separately from the grip unit 170. For example, the accommodation housing 150 may be integrally configured with the grip unit 170 or may be a part of the grip unit 170.

The button unit 180 is coupled to the grip unit 170 and is operated by a user to move the ejecting unit 140. Thus, the button unit 180 is configured to move in conjunction with the ejecting unit 140, and the user can easily disconnect the connector 110 from the coupling housing 120 by moving the button unit 180 in the Y-axis direction.

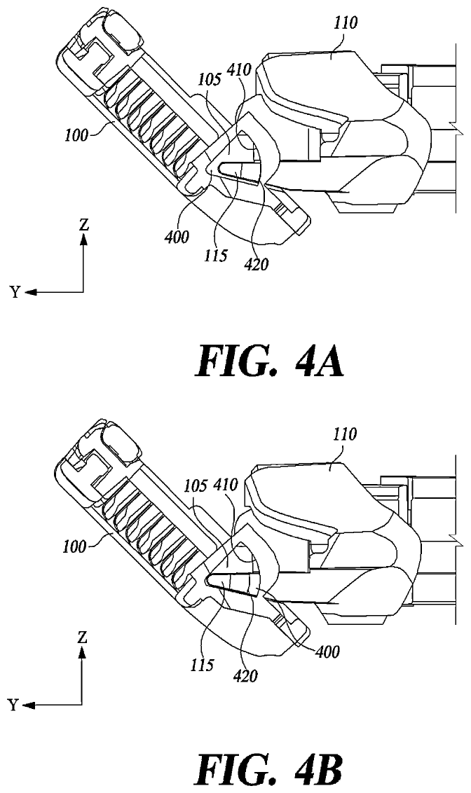

FIGS. 4A and 4B are side cross-sectional views of some components of the razor assembly shown in FIG. 3, cut in the C-C′ direction of FIG. 3.

FIG. 4A illustrates an undepressed state in which a razor cartridge according to at least one embodiment of the present disclosure is not depressed, while FIG. 4B illustrates a depressed state in which a razor cartridge according to at least one embodiment of the present disclosure is depressed by shaving. Herein, the depressed state may mean that both the left and right regions of the blade housing 100 are depressed rearwardly against the connector 110 by the user's skin during shaving.

Referring to FIGS. 4A and 4B, gaps 400 may be formed between the one or more coupling protrusions 115 and the one or more coupling holes 105 either forward or backward of the one or more coupling protrusions 115 to allow the blade housing 100 to rotate about a second rotational axis perpendicular to the longitudinal direction of the blade housing 100. Herein, the second rotational axis may refer to the B-B′ direction of FIG. 3 and may pass through a central region of the blade housing 100 perpendicular to its longitudinal direction.

For example, referring to FIG. 4A, when the blade housing 100 is undepressed, the gaps 400 may be formed forwardly of the one or more coupling protrusions 115, preferably between forward ends of the one or more coupling protrusions 115 and front portions of the one or more coupling holes 105. Additionally, referring to FIG. 4B, when the blade housing 100 is depressed, the gaps 400 may be formed at the rear of the one or more coupling protrusions 115, preferably between the rear ends of the coupling protrusions 115 and the rear portions of the one or more coupling holes 105.

With the gaps 400 formed between the one or more coupling protrusions 115 and the one or more coupling holes 105, the blade housing 100 can be rotated about the first rotational axis as well as the second rotational axis. Furthermore, the blade housing 100 is capable of pivoting about the first rotational axis in an undepressed state as well as in a depressed state.

Although not shown in the drawings, an elastic body (not shown) may be disposed in at least a portion of the gaps 400. Where an elastic body is disposed, it may prevent noise due to pivoting and movement of the blade housing 100, and may also absorb shock applied to the blade housing 100.

When the blade housing 100 pivots about the second rotational axis or is under pressure, the restoring force-providing unit 130 can provide support to the blade housing 100 as well as provide restoring force.

For example, where the restoring force-providing unit 130 includes the plunger 132 and the elastic member 134, the plunger 132 may be configured to move in the y-axis direction in response to pivoting and/or pressurization of the blade housing 100 about the second rotational axis. Further, the elastic member 134 may be configured to contract when the plunger 132 moves in the negative Y-axis direction. In this case, the elastic member 134 may provide positive Y-axis restoring force to the plunger 132.

On the other hand, the one or more coupling holes 105 may be formed in pairs on both longitudinal sides of the blade housing 100, and the one or more coupling protrusions 115 may also be formed in pairs, each connected to a pair of coupling holes 105. In this case, the pair of coupling holes 105 and the pair of coupling protrusions 115 may form a pair of gaps 400.

When the blade housing 100 is undepressed, the pair of gaps 400 may each be formed in front of each of the pair of coupling protrusions 115. When the blade housing 100 is depressed, the pair of gaps 400 may each be formed in the rear of each of the pair of coupling protrusions 115.

Additionally, when the blade housing 100 pivots about the second rotational axis and where a pressing force is further applied to one of the left and right regions of the blade housing 100, one gap of the pair of gaps 400 may occur forwardly of the coupling protrusion corresponding to that gap, and the other gap may occur rearwardly of the coupling protrusion corresponding to that other gap. Depending on the size of the pair of gaps 400, the angle at which the blade housing 100 can pivot about the second rotational axis may be adjusted.

Meanwhile, the one or more coupling holes 105 may include a first surface 410, and the one or more coupling protrusion 115 may include a second surface 420 disposed in front of the first surface 410 and corresponding to the first surface 410. Herein, the forward of the first surface 410 may refer to a positive Y-axis direction.

Additionally, the first surface 410 may have a curved surface, for example, a concave curved surface, and the second surface 420 may have a convex curved surface corresponding to the curved surface of the first surface 410. In this case, the curved surface of the first surface 410 and the curved surface of the second surface 420 may have a profile of an arc centered on the first rotational axis. However, the curved surfaces of the first surface 410 and the second surface 420 do not necessarily have to have an arc profile and may have a circular profile.

Referring to FIG. 4A, when the blade housing 100 in an undepressed state pivots about the first rotational axis, the second surface 420 may be configured to move along the first surface 410 while maintaining abutment with the first surface 410.

Referring to FIG. 4B, when the blade housing 100 in a depressed state pivots about the first rotational axis, the second surface 420 may be configured to move along the first surface 410 while maintaining a distance from the first surface 410.

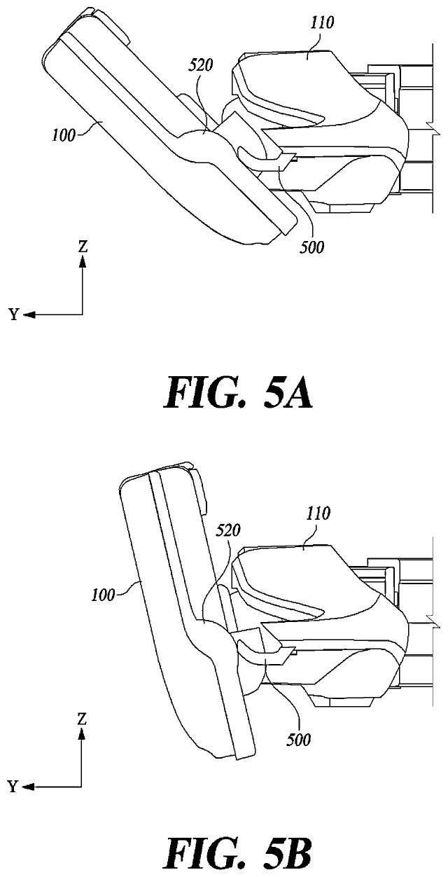

FIGS. 5A and 5B are side views illustrating pivoting about a first rotational axis of a razor cartridge, according to at least one embodiment of the present disclosure.

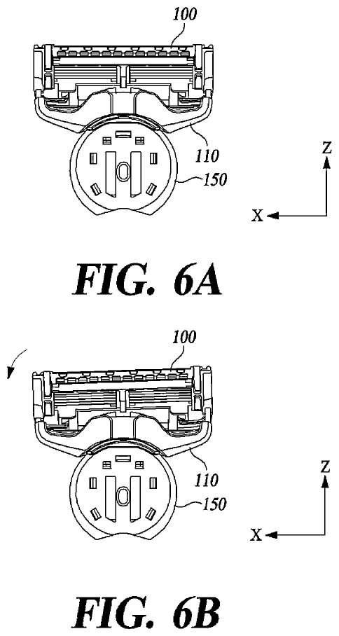

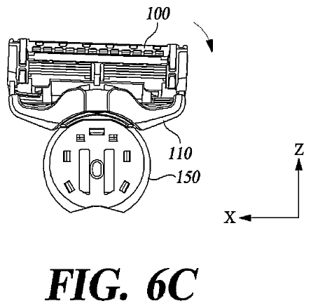

FIGS. 6A to 6C are rear views illustrating pivoting about a second rotational axis of a razor cartridge, according to at least one embodiment of the present disclosure.

Referring now to FIGS. 5A, 5B, and FIGS. 6A through 6C, a razor cartridge according to at least one embodiment of the present disclosure may further include at least one supporting bar 500 formed between the blade housing 100 and the connector 110. The supporting bar 500 may preferably be a plurality, and the plurality of supporting bars 500 may be configured to extend from both longitudinal sides of the connector 110 to support opposite sides of the blade housing 100. In this case, the plurality of support bars 500 may be integrally molded with the connector 110, and may be of the same material as the connector 110.

Thus, when the blade housing 100 pivots about the first rotational axis and/or the second rotational axis, the blade housing 100 may be supported not only by the restoring force providing unit 130 but also by the plurality of support bars 500.

However, the plurality of support bars 500 are not necessarily protruding on both longitudinal sides of the connector 110. Instead, they may be protruding on both longitudinal sides of the blade housing 100. In this case, the plurality of support bars 500 can support opposite sides of the blade housing 100 by contacting the connector 110. Additionally, the plurality of support bars 500 may be integrally molded with the blade housing 100 and may be of the same material as the blade housing 100.

Further, the present disclosure encompasses a configuration of the plurality of support bars 500 to be secured between two longitudinal sides of the connector 110 and two longitudinal sides of the blade housing 100.

Referring now to FIGS. 5A and 5B, a razor cartridge according to at least one embodiment of the present disclosure may further include at least one or more circular guards 520. At least one circular guard 520 is configured to contact at least one support bar 500 at a corresponding contact location.

Preferably, the present disclosure may provide a plurality of circular guards 520 which are formed on opposite sides of the rear surface of the blade housing 100 and configured to abut the plurality of support bars 500. Further, the plurality of circular guards 520 may be configured such that when the blade housing 100 pivots about the first rotational axis, the first rotational axis passes through a radial center of the plurality of circular guards 520.

Accordingly, when the blade housing 100 pivots about the first rotational axis, the blade housing 100 may be supported by the plurality of support bars 500 by maintaining one-side ends of the plurality of support bars 500 in contact along the peripheral surfaces of the plurality of circular guards 520.

Referring to FIGS. 6A through 6C, the plurality of support bars 500 may be elastically deformed to restore the blade housing 100 when rotated about the second rotational axis, to a second rest position. Herein, the second rest position refers to the position of the blade housing 100 before being rotated about the second rotational axis, as illustrated in FIG. 6A.

Referring to FIGS. 6B and 6C, when the blade housing 100 pivots about the second rotational axis, at least one of the support bars 500 may be elastically deformed, whereby the support bars 500 can provide support and restoring force to the blade housing 100. Accordingly, the blade housing 100 may be supported by the restoring force providing unit 130 and the support bars 500 while also being provided with restoring force, to offer a tensioned and a stable shave.

However, providing the restoring force while the blade housing 100 is supported by the restoring force providing unit 130 and the plurality of support bars 500 is not necessarily limited to when the blade housing 100 pivots about the second rotational axis. For example, referring to FIGS. 4A and 4B, when the blade housing 100 is depressed, or when a force is applied to either of the left and right regions of the blade housing 100, the blade housing 100 can also be returned to the first rest position by receiving restoring force from the plurality of support bars 500, thereby enabling a tensioned and stable shave.

On the other hand, the support bars 500 may be an elastic material, for example a plastic, rubber material such as an elastomer, or an elastomer with a thin film embedded therein. In this case, the blade housing 100 can be rotated about the second rotational axis only when the blade housing 100 is pressed to a certain force or more by an elastic force of each of the support bars 500.

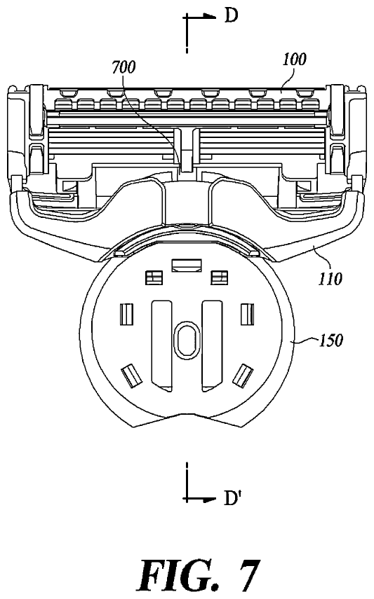

FIG. 7 is a rear assembly perspective view of some components of a razor assembly according to at least one embodiment of the present disclosure.

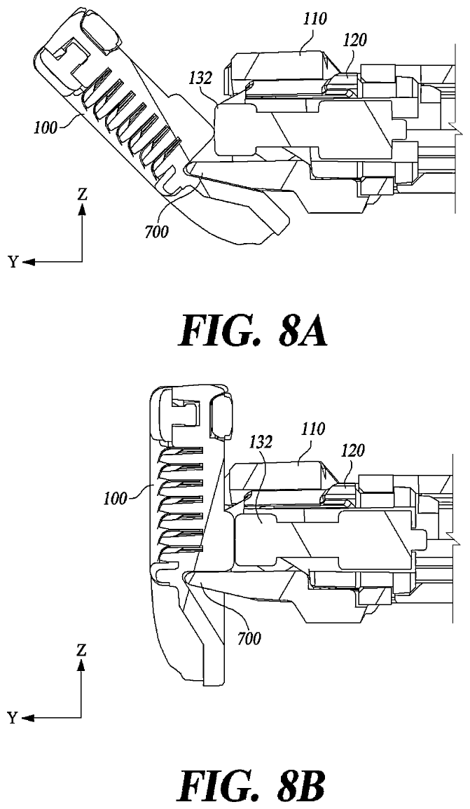

FIGS. 8A and 8B are side cross-sectional views of some components of the razor assembly shown in FIG. 7, cut in the D-D′ direction of FIG. 7.

Referring to FIGS. 7, 8A, and 8B, the connector 110 according to at least one embodiment of the present disclosure may include a center supporting unit 700. The center supporting unit 700 may extend forwardly from the connector 110 and may be positioned adjacent to the rear surface of the blade housing 100. In this case, the center supporting unit 700 may be configured to support a central region of the rear surface of the blade housing 100 when it is in a depressed state.

The center supporting unit 700 may be configured to be spaced apart from the blade housing 100 by a predetermined distance when the blade housing 100 is undepressed, but the present disclosure is not necessarily limited to this configuration. However, as illustrated in FIGS. 8A and 8B, when the blade housing 100 is depressed, the center supporting unit 700 is preferably configured with one end thereof to be in touch with the first rotational axis so that the blade housing 100 can rotate about the first rotational axis.

The blade housing 100 is supported by the center supporting unit 700 as well as the restoring force providing unit 130 to allow the shaving blade 200 to be more closely pressed against the skin during shaving. In addition, the center supporting unit 700 may serve as a central support point to prevent the blade housing 100 from over-pivoting about the second rotational axis.

As described above, the razor cartridge according to at least one embodiment of the present disclosure may have multiple rotational axes and may be configured to provide restoring force during pivoting, which has the effect of allowing the razor cartridge to conform to the curvatures of the user's skin.

Although exemplary embodiments of the present disclosure have been described for illustrative purposes, those skilled in the art will appreciate that various modifications, additions, and substitutions are possible, without departing from the defining features of the embodiments. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

What is claimed is:

1. A razor cartridge, comprising:
a blade housing configured to receive at least one or more shaving blades in a longitudinal direction, a coupling hole formed in a rear surface of the blade housing; and
a connector comprising a coupling protrusion, the coupling protrusion connected to the coupling hole and rotatable about a first rotational axis parallel to the longitudinal direction,
wherein the coupling protrusion forms a gap between the coupling hole to allow the blade housing to pivot about a second rotational axis perpendicular to the longitudinal direction.

2. The razor cartridge of claim 1, wherein the gap is configured to be formed at a front side of the coupling protrusion in response to the blade housing being undepressed, and wherein the gap is configured to be formed at a rear side of the coupling protrusion in response to the blade housing being depressed.

3. The razor cartridge of claim 1, wherein the blade housing includes a pair of coupling holes formed on two longitudinal sides of the blade housing,
wherein the connector includes a pair of coupling protrusions connected to the pair of coupling holes,
wherein the pair of coupling holes and the pair of coupling protrusions form a pair of gaps comprising a first gap and a second gap,
wherein the first gap is configured to be formed at a front side of a first one of the coupling protrusions, corresponding to the first gap, and
wherein the second gap is configured to be formed at a rear side of a second one of the coupling protrusions, corresponding to the second gap, in response to the blade housing having pivoted about the second rotational axis.

4. The razor cartridge of claim 1, wherein the blade housing includes a pair of coupling holes formed on two longitudinal sides of the blade housing,
wherein the connector includes a pair of coupling protrusions connected to the pair of coupling holes, and
wherein the pair of coupling holes and the pair of coupling protrusions form a pair of gaps that are configured to be formed at a rear side of the pair of coupling protrusions, respectively, in response to the blade housing being depressed.

5. The razor cartridge of claim 1, wherein the coupling hole comprises a first surface,
wherein the coupling protrusion comprises a second surface disposed forward of the first surface and corresponding to the first surface, and
wherein the second surface is configured to move along the first surface in contact with the first surface in response to the blade housing in an undepressed state pivoting about the first rotational axis.

6. The razor cartridge of claim 5, wherein the second surface is configured to move along the first surface with the second surface spaced apart from the first surface in response to the blade housing in a depressed state pivoting about the first rotational axis.

7. The razor cartridge of claim 5, wherein the first surface has a concave curved surface,
wherein the second surface has a convex curved surface corresponding to the concave curved surface of the first surface, and
wherein the concave curved surface of the first surface and the convex curved surface of the second surface have a profile of an arc centered on the first rotational axis.

8. The razor cartridge of claim 1, further comprising:
a plurality of supporting bars formed between the blade housing and the connector and configured to support opposite sides of the blade housing.

9. The razor cartridge of claim 8, wherein the support bars are configured to be elastically deformed to restore the blade housing to a second rest position in response to the blade housing pivoting about the second rotational axis.

10. The razor cartridge of claim 8, further comprising:
a plurality of circular guards formed on opposite sides of the rear surface of the blade housing and abutting the plurality of support bars,
wherein the plurality of circular guards are configured to allow the first rotational axis to pass through a radial center of the plurality of circular guards in response to the blade housing pivoting about the first rotational axis.

11. The razor cartridge of claim 1, wherein the connector comprises:
a center supporting unit configured to support a central region of the rear surface of the blade housing in response to the blade housing being in a depressed state.

12. A razor assembly, comprising:
a blade housing configured to receive at least one or more shaving blades in a longitudinal direction, a coupling hole formed in a rear surface of the blade housing;
a connector comprising a coupling protrusion, the coupling protrusion connected to the coupling hole and rotatable about a first rotational axis parallel to the longitudinal direction; and
a restoring force-providing unit configured to provide restoring force for restoring the blade housing in response to pivoting to a first resting position,
wherein the coupling protrusion forms a gap between the coupling hole to allow the blade housing to pivot about a second rotational axis perpendicular to the longitudinal direction.

13. The razor assembly of claim 12, wherein the restoring force-providing unit comprises:
a plunger configured to transmit the restoring force in cam action with the blade housing; and
an elastic member configured to provide an elastic force to the plunger.
